(19) United States
(12) Patent Application Publication
(10) Pub. No.: US 2005/0071786 A1
(43) Pub. Date: Mar. 31, 2005

(54) Timing and distance control for displaying dynamic information

(75) Inventors: Rico Mariani, Kirkland, WA (US); Bradford A. Christian, Redmond, WA (US); Julie B. Larson, Redmond, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation, Redmond, WA (US)

(21) Appl. No.: 10/966,577

(22) Filed: Oct. 15, 2004

Related U.S. Application Data
(63) Continuation of application No. 08/476,396, filed on Jun. 7, 1995.

(51) Int. Cl. G09G 5/08

(52) U.S. Cl. 715/967; 345/157

(57) ABSTRACT

Time and distance metrics are used to control when dynamic information represented by a visual representation to which a cursor points is displayed on a video display. A time metric is used to provide a non-negligible time delay between when the mouse cursor is initially pointing to the visual representation and when the information is displayed. This time delay prevents the user from receiving undesired information when the user inadvertently passes the mouse cursor over the visual representation. In addition, a distance metric is used to monitor the movement of the mouse cursor, so that the information is displayed when the mouse cursor remains within a predetermined distance of the visual representation during the time delay. This monitoring of movement of the mouse cursor provides the user with information even if the mouse cursor is inadvertently moved a predetermined distance.

### CROSS-REFERENCE TO RELATED CASES

This application is a continuation application and claims priority to U.S. patent application Ser. No. 08/476,396, filed Jun. 7, 1995, entitled “Timing and Distance Control for Displaying Dynamic Information”, and the Continued Prosecution Applications thereof which are incorporated herein by reference in its entirety.

### TECHNICAL FIELD

The present invention relates generally to data processing systems and more particularly to the display of dynamic information in data processing systems.

### BACKGROUND OF THE INVENTION

Conventional development environments provide debugging programs for enabling a user to debug source code in an application program. Source code refers to an application program written in a high-level language, such as the C++ programming language. Debugging is a process of removing errors in the source code and is typically done by stepping through the statements in the application program.

The statements in the source code include variables, which are named storage locations capable of containing a predefined type of data that can be modified during application program execution. For example, a variable denoted as “count,” of an integer data type, may contain the count of the number of items in a list. Initially, the variable “count” may contain the value of five, indicating that the list initially contains five items. As the number of items in the list changes, the value of the variable “count” changes.

One conventional debugging environment, Visual C++, Version 2.0, from Microsoft Corporation, of Redmond, Wash., provides a “window” method for viewing the values of variables. With this method, a user selects a variable by pointing to it with a mouse. Then, the user enters a key on the keyboard or selects a menu item from a menu displayed on a video display to open a dialog box. Using the dialog box, the user finds the value of the variable and then closes the dialog box. Because the user takes several steps to obtain the desired information, this method may be distracting to a user who is focusing on debugging.

The user should have a quick and easy method of obtaining the value of a variable that the user is interested in without having the information obscure other necessary information on the video display.

### SUMMARY OF THE INVENTION

In accordance with a first aspect of the present invention, a method is practiced in a data processing system having a video display for displaying a cursor that points to positions on the video display. The data processing system also includes an input device for manipulating the cursor. In accordance with this method, it is first determined that the cursor points to a position on the video display. A time period is measured that specifies how long the cursor has remained pointing within a predetermined distance of the position. Upon expiration of the measured time period, the method determines whether a data item is denoted by the position to which the cursor points. When it is determined that the data item is denoted by the position, an event is triggered.

In accordance with a second aspect of the present invention, a visual representation of a data item is displayed on the video display. Then, in response to a user using the input device, the cursor is positioned to point to the visual representation of the data item. After waiting a predetermined period of time, it is determined whether the cursor remained pointing to the visual representation of the data item during the predetermined period of time. Where it is determined that the cursor remained pointing to the visual representation of the data item during the predetermined period of time, information about the data item is displayed adjacent to the data item on the video display.

In accordance with an additional aspect of the present invention, a method is practiced in a data processing system having a video display for displaying a data item, which has a first value and a visual representation, and a cursor that points to the visual representation of the data item on the video display. The method also includes an input device for manipulating the cursor. In accordance with this method, the first value of the data item is displayed adjacent to the data item on the video display. Then, in response to a user using the input device, the displayed first value is removed. Next, in response to a user using the input device, it is determined that the cursor again points to the visual representation of the data item on the video display. Then, a second value of the data item is determined, which may be different from the first value of the data item, and this second value of the data item is displayed adjacent to the data item on the video display.

In accordance with another aspect of the present invention, a method is practiced in a data processing system having an operating system, a video display for displaying a cursor that points to positions on the video display, and an input device for manipulating the cursor. An application program which is written in source code to be debugged is provided, and the application program includes a data item having a value and a visual representation. Also, a debugging program for debugging the application program is provided. In addition, a text editor program for displaying the application program is provided. Then, it is determined with the text editor program that the cursor is positioned to point at the visual representation of the data item. Next, the value of the data item is determined with the debugging program when it receives a request for the value from the text editor program. The visual representation of the data item along with its value is displayed on the video display with the text editor program when it receives the value from the debugging program.

In accordance with yet another aspect of the present invention, a method is practiced in a data processing system having a video display for displaying a cursor that points to positions on the video display. The data processing system displays a visual representation of a data item having a plurality of characters on the video display. In addition, the data processing system includes an input device for manipulating the cursor. First, it is determined that the cursor points to a position on the video display. Then it is determined whether the position indicates the cursor is pointing to one of the characters of the visual representation of the data item. Where it is determined that the position indicates the cursor is pointing to one of the characters of the visual representation of the data item, the visual representation of the data item is determined.

In accordance with a further aspect of the present invention, a data processing system includes a video display for displaying video data. The video display displays a visual representation of the data item and a cursor that points to the visual representation of the data item. The data processing system also includes an input device for moving the cursor on the video display. A message generator is provided for displaying information about the data item adjacent to the data item on the video display when the cursor remains pointing to the visual representation of the data item for a predetermined non-negligible amount of time. The message generator includes a comparator for determining whether the cursor has remained pointing to the visual representation of the data item for the predetermined non-negligible amount of time. The message generator also includes a message source for retrieving and displaying the information about the data item adjacent to the data item on the video display when the comparator determines that the cursor has remained pointing to the visual representation of the data item for the predetermined amount of time.

In accordance with a still further aspect of the present invention, a data processing system includes a video display for displaying video data, including a data item having a visual representation and a cursor, and an input device for moving the cursor on the video display. The data processing system has means for determining that the cursor points to a position on the video display. It also has means for waiting a predetermined period of time, and means for determining that the cursor remains pointing to within a predetermined distance from the position on the video display during the predetermined period of time. In addition, the data processing system has means for determining that the cursor points to the visual representation of the data item. The data processing system includes means for displaying information about the data item adjacent to the data item on the video display when it is determined that the cursor points to the visual representation of the data item.

### BRIEF DESCRIPTION OF THE DRAWINGS

FIG. 1 is a block diagram of a data processing system that is suitable for practicing the preferred embodiment of the present invention.

FIG. 2 displays a sample user interface that is displaying a data tip in accordance with the preferred embodiment of the present invention.

FIG. 3 is a flowchart illustrating the steps performed when the mouse cursor points to a white space in accordance with the preferred embodiment of the present invention.

FIG. 4 is a flowchart illustrating the steps performed to determine whether a mouse cursor points at the visual representation of a data item in accordance with the preferred embodiment of the present invention.

FIG. 5 is a flowchart illustrating the steps performed to initially set a timer when a cursor is moved in accordance with the preferred embodiment of the present invention.

FIG. 6 is a flowchart illustrating the steps performed to determine whether the mouse cursor remains pointing within a predetermined distance of a position for a predetermined period of time in accordance with the preferred embodiment of the present invention.

FIG. 7 is a flowchart illustrating the steps performed to determine whether a data tip is to be displayed in accordance with the preferred embodiment of the present invention.

FIG. 8 is a flowchart illustrating the steps performed when a mouse or keyboard message is received while a data tip is displayed in accordance with the preferred embodiment of the present invention.

### DETAILED DESCRIPTION OF THE INVENTION

The preferred embodiment of the present invention displays the current value of a data item, which is a symbolic representation of a value, when a mouse cursor points to a visual representation of the data item for longer than a predetermined amount of time. The current value of the data item is displayed along with the visual representation of the data item in a rectangle. The displayed value and rectangle constitute a “data tip.” The preferred embodiment of the present invention facilitates the display of dynamic information in such data tips. Dynamic information refers to information that is not static and that may change during execution of an application program. The preferred embodiment of the present invention is especially well adapted for use in a software development environment, wherein code is being debugged. In such an environment, the data items are variables, expressions and the like.

The preferred embodiment provides a time delay between when the mouse cursor is initially pointing to the visual representation of the data item and when the data tip is displayed. This time delay prevents the user from receiving undesired data tips when the user inadvertently passes the mouse cursor over a visual representation of the data item. The time delay is sufficiently long (i.e., it is non-negligible) to allow the user to move the mouse cursor off of the visual representation of the data item in order to avoid receiving a data tip. Moreover, during the time delay, the preferred embodiment monitors the movement of the mouse cursor, and if the mouse cursor remains within a predetermined area during the time delay, the preferred embodiment provides a data tip. This monitoring of movement of the mouse cursor provides the user with data tips even if the mouse cursor is inadvertently moved a predetermined distance.

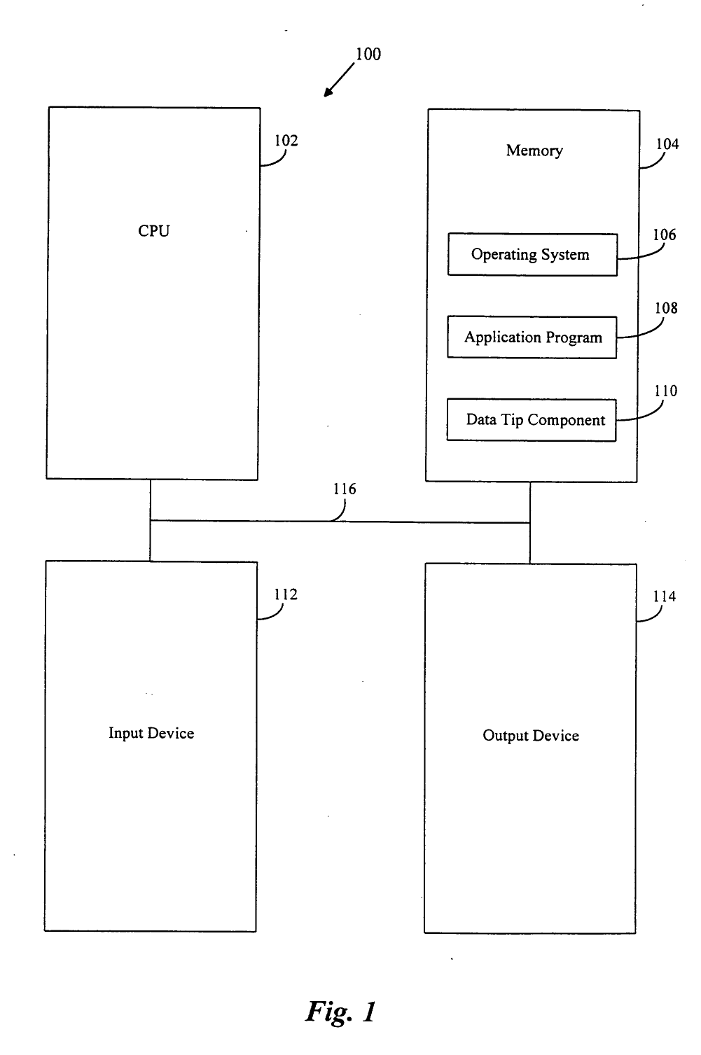

FIG. 1 is a block diagram of a data processing system 100 that is suitable for practicing the preferred embodiment of the present invention. The data processing system 100 includes at least one central processing unit (CPU) 102. The CPU 102 is connected to a number of peripheral devices, including a memory 104, an input device 112, such as a mouse or a keyboard, and an output device 114, such as a video display having a screen. The memory 104 holds a copy of an operating system 106, such as the Microsoft Windows NT, Version 3.5 operating system, sold by Microsoft Corporation of Redmond, Wash. The memory 104 also holds an application program 108 and a data tip component 110. The components of the computer system are connected by a connection mechanism 116, such as a bus.

When the user uses an input device, such as a mouse 112, to point at a position on the video display 114, the operating system 106 determines the (X, Y) coordinates of the position and sends this information in a message that is forwarded to the data tip component 110. The data tip component determines whether the mouse cursor is pointing to a visual representation of a data item, which may contain alphanumeric and underbar characters, as will be discussed in more detail below. When the mouse cursor has been pointing to the visual representation of a data item for a predetermined period of time, the data tip component retrieves the current value of the data item and displays the current value of the data item on the video display.

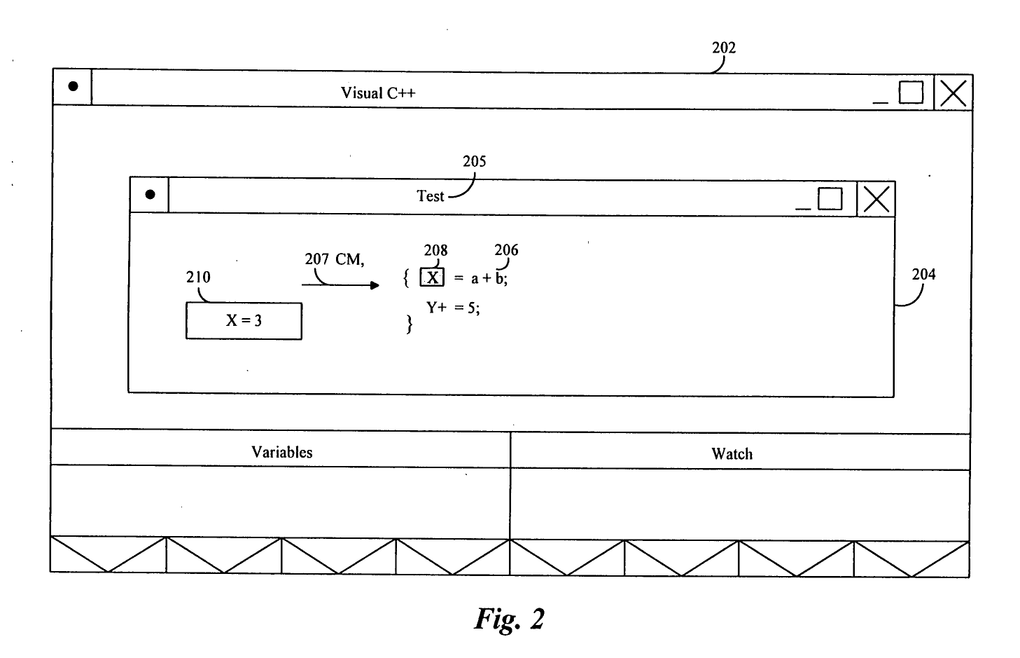

FIG. 2 displays a sample user interface that is displaying a data tip 210. A window 202 for a development environment, Visual C++, is shown. Visual C++ is sold by Microsoft Corporation of Redmond, Wash. Visual C++ contains a debugging program for debugging an application program, such as the application program 108 shown in FIG. 1. The debugging program invokes a text editor program which facilitates viewing and editing of the application program. In the example shown in FIG. 2, the “Test” application program 205, which is written in the C++ programming language, is being debugged. A listing of the “Test” application program is displayed within a text editor window 204, for the text editor program, such as is known in the art. The debugging program displays an arrow 207 beside the line which is currently being debugged in the text editor window 204. A line may contain a comment, white spaces, or a statement of code, which contains data items. For example, the “Test” application program includes a line containing the statement “x=a+b” 206. In this statement, a sample data item has the visual representation of “x” 208. Additionally, the expression “x=a+b” 206 is a visual representation of a data item. When a mouse cursor 112 points to a visual representation of a data item for a predetermined period of time, a data tip is displayed. For example, the data item “x” may be selected by pointing to the visual representation of the data item “x” with the mouse cursor for more than a predetermined amount of time, as will be discussed in more detail below. Then, a data tip displays the visual representation of the data item along with its current value. For example, the data tip 210 indicates that the current value of data item “x” 208 is three. Such data tips are useful in debugging because they allow a user to determine a value for a data item and thus make a determination of whether the value is erroneous.

The user interface provided for the program is logically divisible into a number of windows. For example, a listing of the “Test” application program is displayed within a text editor window 204. In general, each window of the user interface has a separate window procedure associated with it. The operating system 106 maintains a message queue for each application program that generates windows, such as in Microsoft Windows, Version 3.1. Accordingly, the application program 108 has its own message queue. When an event occurs the event is translated into a message that is put into the message queue for the application program. The application program retrieves and delivers the message to the proper window by executing the block of code that is known as the “message loop.” The window procedure that receives the message then processes the message. An event corresponds to the actions of a user. For example, an event may indicate a mouse movement, may indicate the position of a mouse cursor, or may indicate a keystroke received from a keyboard.

Movements of the mouse are reflected in messages that are placed into the message queue of the application program. In particular, when a user positions a mouse cursor with the mouse 112 over a window, the procedure for the window receives a mouse message. The operating system 106 provides a number of predefined mouse messages. The mouse messages specify the status of mouse buttons and the position of the mouse cursor within the screen of the video display 114. The position of the mouse cursor within the screen is specified in (X, Y) coordinates relative to the upper left-hand corner of the screen. When the mouse cursor moves within the screen, the position of the mouse cursor is adjusted to reflect the (X, Y) coordinates within the window relative to the upper left-hand corner of the window. The window procedure receives the mouse message and utilizes the information contained in the message to respond to the mouse activities.

The “Test” application program 205, which contains source code to be debugged, has a number of different data items. A user may select a data item in order to view a data tip for that data item. The visual representation of a data item includes one or more alphanumeric or underbar characters. A user may select a data item by pointing to a character of the visual representation of the data item with a mouse cursor. In addition, a user may select a data item by highlighting the data item and then pointing to the highlighted data item. Highlighting the data item is done by pointing to the first character of the data item, depressing a mouse button, dragging the mouse cursor over each character of the data item, and releasing the mouse button.

Additionally, if an expression, such as “x=a+b” 208, is selected, then the text editor program will evaluate the current value of the expression. The text editor program recognizes that when an expression is selected, the user desires to view the current value of the data item on the left side of the assignment operator. Specifically, the text editor program recognizes the following assignment operators: =, +=, −=, *=, /=, <<=, >>=, &=, !=, \hat{ }=, ++, and—−−. For example, if a user selects an expression, such as “x=a+b,” the text editor program determines that the user desires to view the current value of data item “x.”

When a user points to a position in the text editor window 204, the window procedure for the text editor window receives a mouse message that indicates the position of the mouse cursor in the text editor window. The text editor window associates this position with a character in the text. The text editor program knows which displayed characters are associated with data items and how to associate these data items with values by calling the debugging program.

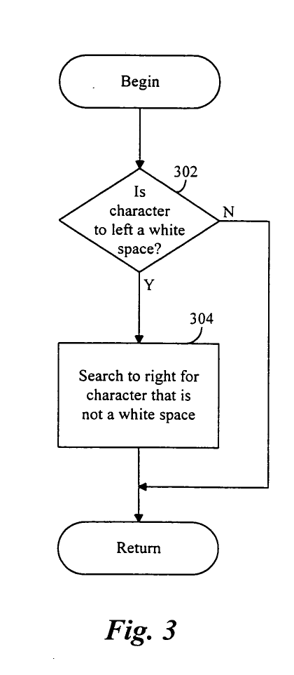

The steps that are performed when the mouse cursor points to a white space (e.g., a space character or a tab character) are shown in FIG. 3. When a mouse cursor points to white space, the text editor program determines whether a data item is near the position of the mouse cursor, and if the text editor program finds a data item, it displays a data tip. Specifically, when the mouse cursor points to a white space, the text editor program determines whether the character to the left of the mouse cursor is a white space (step 302). If the character is not a white space, the text editor program determines whether the character is part of a visual representation of a data item, and if so, displays a data tip. Otherwise, the text editor program searches to the right of the mouse cursor for the first character which is not a white space (step 304), on the line of source code which is currently being debugged. If the text editor program finds a character which is not a white space, the text editor program determines whether the character is part of a visual representation of a data item, and if so, displays a data tip.

When the mouse cursor is positioned over a character for a predetermined amount of time, the text editor program determines whether the character is part of a visual representation of a data item. If so, the text editor program calls the debugger editor program with the visual representation of the data item. The debugging program returns to the text editor program the current value of the data item which is to be displayed. The text editor program then displays a data tip. A data tip provides dynamic information which may assist a user who is debugging an application program. In particular, if a value of a data item should be 6 and the data tip indicates the current value is actually 600, the user may receive some insight into what the problem with the source code is.

The debugging program maintains a listing of all the visual representations of the data items in the source code along with their values. In particular, because the value of a data item is dynamic and may change over time, the debugging program maintains the current values of data items for particular instances of time. Therefore, the debugging program is able to provide the current value of the data item for the instance of time that it is requested. The text editor program may send the debugging program a visual representation of a data item made of alphanumeric and underbar characters which is part of a comment. If this visual representation does correspond to the visual representation of a data item, then the debugging program retrieves its value and returns the value to the text editor program. However, if the visual representation from the comment does not correspond to a data item, then the debugging program returns an indication that this visual representation has no corresponding value, and no data tip is displayed. If the text editor program receives a current value from the debugging program, it displays a data tip containing the visual representation of the data item along with its retrieved current value.

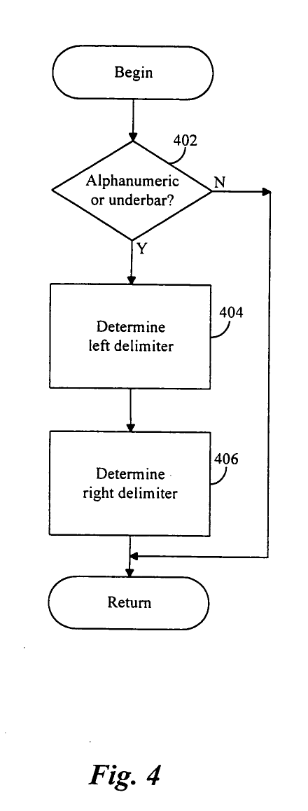

In order to determine whether the mouse cursor points at the visual representation of a data item, the steps of FIG. 4 are performed. The data items are not at predetermined locations. Instead, upon determining that the mouse cursor points to a character, the text editor program determines whether the mouse cursor is pointing to a visual representation of a data item. Initially, the mouse cursor points to a character on the video display. The text editor program determines whether the character is an alphanumeric character or an underbar character (step 402). Because visual representations of data items do not contain characters other than alphanumeric and underbar characters, if any other character is found, the text editor program returns. If the character is an alphanumeric or underbar character, the text editor program determines the left and right delimiters of the visual representation of the data item. Specifically the text editor program determines the left delimiter of the visual representation (404). In particular, the text editor program searches for characters to the left of the mouse cursor position until finding a character other than an alphanumeric or underbar character, and this character is a left delimiter. Next, the text editor program determines the right delimiter of the visual representation (406). Specifically, the text editor program searches for alphanumeric characters to the right of the first alphanumeric character until a character other than an alphanumeric or underbar character is found, and this character is a right delimiter. The characters between the left and right delimiters represent the visual representation of the data item.

The data tip is displayed using a text output command which is provided by the operating system 106. Specifically, the TextOut ( ) function that is provided by the Microsoft Windows NT, Version 3.5, operating system is used in the preferred embodiment. The format of this function is as follows:
BOOLEAN TextOut(hdc, nXStart, nYStart, lpString, cbString)
   HDC hdc; // handle of device context
   int nXStart; // X coordinate of starting position
   int nYStart; // Y coordinate of starting position
   LPCTSTR lpString; // address of string
   int cbString; // number of characters in string

The hdc parameter of this function specifies a handle (i.e., a numerical identifier) for a device context. In this case, the device context specifies attributes that determine how the operating system interacts with the video display 112. The nXStart parameter specifies the logical X coordinate at which the string of the data tip message begins. Similarly, the nYStart parameter specifies the logical Y coordinate at which the string begins. The lpString parameter is a pointer to a structure which holds the textual the string to be displayed in the data tip. The cbString parameter specifies the number of bytes in the string.

The data tip is provided in a clipped rectangle for which the background color may be specified. In a preferred embodiment of the present invention, the background color is yellow, as specified in red/green/blue (RGB) coordinates as (255, 255, 128). The text indicating the current value of the data item is typically displayed in black. A data tip is typically displayed in a rectangle whose upper left corner is placed 10 pixels to the right of the mouse cursor and 10 pixels below the mouse cursor. When using these coordinates would place part or all of the rectangle off of the video display, the coordinates are adjusted. Those skilled in the art will appreciate that the choice of 10 pixels is not intended to be limiting of the present invention; rather, 10 pixels is a value used in the preferred embodiment of the present invention. The rectangle has a width equal to the width of the text plus one character and a height equal to the height of the text plus one pixel.

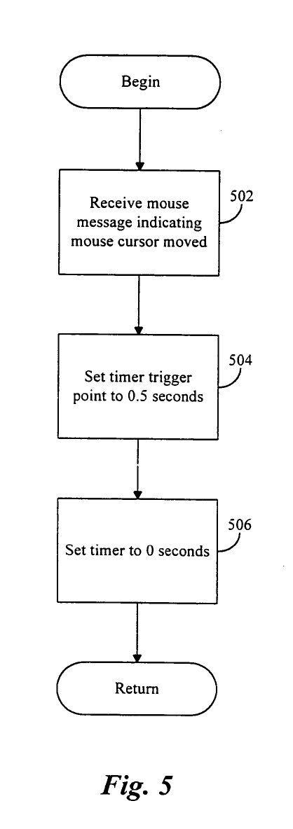

In order to determine whether to display a data tip, the text editor window first receives an indication that the mouse cursor has moved. When the mouse cursor is moved, the steps shown in FIG. 5 are performed. Initially, the window procedure for the text editor window receives a mouse message indicating that the mouse cursor has moved (502). When the mouse cursor moves, the text editor program starts a timer. The text editor program uses a timer to determine whether or not to display a data tip. This timer may be a system-provided resource that is provided by the operating system or may be a separate component that is provided by the text editor program. The data tip is displayed when the timer counts up to a preset trigger point and the mouse cursor is within a predetermined distance of its initial position. The timer trigger point is then set to 0.5 seconds (step 504). The timer trigger point is non-negligible, and in a preferred embodiment, an acceptable timer trigger point may be at least 0.1 seconds and not more than 2.0 seconds. The timer trigger point is 0.5 seconds in a preferred embodiment of the present invention. Those skilled in the art will appreciate that the choice of 0.5 seconds is not intended to be limiting of the present invention; rather, 0.5 seconds is a value used in the preferred embodiment of the present invention, which appears to empirically produce desirable results. At the end of the time period, the timer is reset to zero seconds so that it can begin counting time (step 506). If the mouse cursor remains pointing within a predetermined distance of its initial position during the time period, a data tip is displayed.

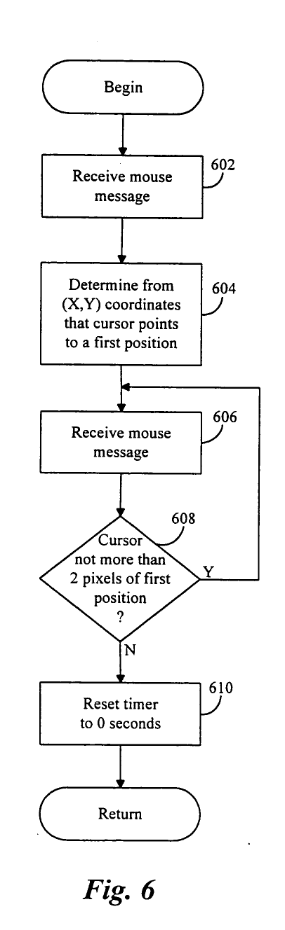

When the timer is started, the steps shown in FIG. 6 are performed. First, the text editor program receives a mouse message indicating the (X, Y) coordinates of the mouse cursor (step 602). Next, the text editor program determines from the (X, Y) coordinates that the mouse cursor points to a first position (step 604). The text editor program then receives another mouse message indicating the current position of the mouse cursor (step 606). Because a mouse is a sensitive device and even a movement of the surface on which a mouse rests may cause a movement of the mouse cursor a few pixels, the preferred embodiment monitors movement of the mouse and determines that a user indicates an intent to move the mouse cursor only if a mouse movement greater than 2 pixels is received. Upon receiving another mouse message, the text editor program determines whether the mouse cursor is not more than 2 pixels from the first position (step 608). The mouse cursor is not more than 2 pixels from the first position if the difference between the X coordinate of the first position and the X coordinate of the current position is less than or equal to 2 pixels and the difference between the Y coordinate of the first position and the Y coordinate of the current position is less than or equal to 2 pixels. If the mouse cursor has not been moved more than 2 pixels from the first position, the text editor program loops to receive another mouse message. If the mouse cursor has been moved more than 2 pixels, the text editor program resets the timer to zero seconds (step 610).

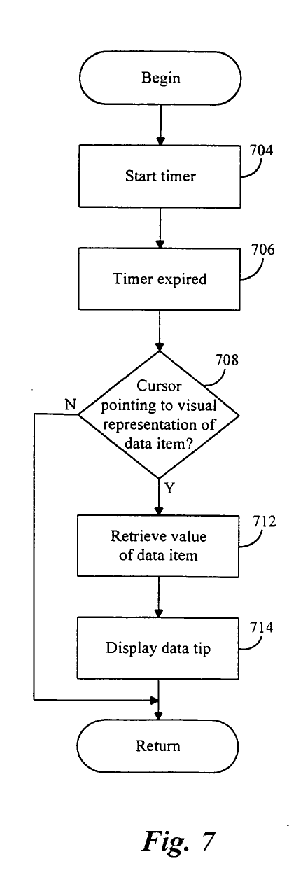

FIG. 7 is a flowchart indicating the steps performed to display a data tip. Initially the text editor program receives a mouse movement and a coordinate position indicating a first position of the mouse cursor. Then the text editor program starts a timer (step 704). When the timer expires with the mouse cursor having remained pointing to within a predetermined distance of the first position during the time interval (step 706), the text editor program determines whether the mouse cursor is pointing to the visual representation of a data item (step 708). If the mouse cursor is pointing to the visual representation of a data item, then the text editor program retrieves the current value of the data item (step 712). In particular, the text editor program obtains the current value of the data item from the debugging program which maintains a listing of the values for these dynamic data items. Then the text editor program displays the data tip (step 714). If the mouse cursor is not pointing to the visual representation of a data item, then the text editor program returns.

The time duration for which the mouse cursor remains pointing to a visual representation of a data item provides helpful indications of the intent of the user. Empirical tests indicate that users typically will leave the mouse cursor pointing to a visual representation of a data item for a time period greater than 0.5 seconds if they wish to receive the current value of the data item. In contrast, when users do not wish to receive the current value of a data item, and they are merely passing over the visual representation of the data item, the user does not hold the mouse cursor over the visual representation of the data item for a sufficient amount of time to indicate an intent.

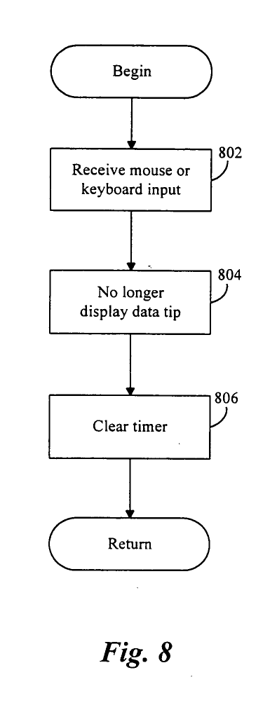

FIG. 8 illustrates the steps performed when the text editor program receives a mouse or keyboard message while a data tip is displayed. The text editor program first receives a message indicating a mouse cursor movement which is more than 2 pixels in any direction, a mouse click, or a keyboard input (step 802). Upon receiving the message, the text editor program no longer displays the data tip (step 804). Then the text editor program clears the timer (step 806).

While the present invention has been described with reference to a preferred embodiment thereof, those skilled in the art will appreciate the various changes in form and detail may be made without departing from the intended scope of the present invention as defined in the appended claims. In particular, although the preferred embodiment of the present invention discusses a mouse as a pointing device, those skilled in the art would recognize that other pointing devices may be used. Additionally, although the preferred embodiment indicates selection of a data item using a mouse, those skilled in the art would recognize other methods of selecting a data item.

1. A debugger comprising:
a text editor that displays a section of source code of a program to be debugged in a text editing window on a video display, the source code comprising a statement including at least one data item of a plurality of data items, the at least one data item having a value;
a program debugger that maintains a list of the plurality of data items, the list comprising the at least one data item and the value of the data item, the value comprising a first value, the debugger updating the value of the at least one data item to a second value in response to determining that the value of the at least one data item changed from the first value to the second value as a result of execution of the program to be debugged; and
a data point component that in response to determining that a user input device has pointed to the at least one data item or a white space adjacent to the at least one data item in the text editing window for a specified time period, receives the value of the at least one data item from the program debugger list, and displays in the text editing window on the video display a representation of the at least one data item and the value adjacent to the at least one data item.

2. The debugger of claim 1, wherein the displayed value is a first value and in response to detecting that a cursor was moved away from the at least one data item and returned to the at least one data item, displaying the second value adjacent to the at least one data item in place of the first value in the text editing window on the video display.

3. The debugger of claim 1, wherein the displayed value is displayed within a rectangle having a width of the at least one data item plus one pixel and a height of the at least one data item plus one pixel.

4. A method for displaying debugging information comprising:
determining that a cursor points to a position on a video display, the video display displaying a section of source code of a program to be debugged in a text editing window, the source code comprising a statement including at least one data item of a plurality of data items, the at least one data item having a value;
measuring a time period that specifies how long the cursor has remained pointing within a predetermined distance of the position;
upon expiration of the measured time period, in response to determining that the at least one data item is denoted by the position to which the cursor points, displaying a value of the at least one data item adjacent to the at least one data item on the video display, wherein the displayed value is displayed within a rectangle having a width of the at least one data item plus one pixel and a height of the at least one data item plus one pixel.

5. The method of claim 4, wherein the position on the video display is a first position, wherein in response to using an input device to move the cursor to a second position, the value adjacent to the at least one data item on the video display is removed.

6. The method of claim 5, wherein the value is a first value and in response to returning the cursor to the first position, a second value of the at least one data item is displayed.

7. The method of claim 6, wherein the first value is different than the second value in response to execution of the source code.

8. A method in a computer system for displaying a current value of a displayed dynamic data item, the computer system including a pointing device that may be manipulated by a user to position a cursor on a display, the dynamic data item being defined in a computer program, the method comprising:
determining that the user has used the pointing device to position the cursor over the displayed dynamic data item for at least a predetermined period of time; and
in response to such determining, displaying in context within the computer program and adjacent to the displayed dynamic data item a data tip including an identification of the dynamic data item and the current value of the dynamic data item.

9. The method of claim 8, further comprising displaying the data tip in a manner so as not to obscure the displayed dynamic data item.

10. The method of claim 9, wherein the data item is a variable.

11. The method of claim 9, wherein the data item is an expression.

12. The method of claim 9, wherein the data item is an element of a data structure.

13. The method of claim 9, further including:
after displaying the value of the dynamic data item, receiving a new value for the dynamic data item; and
displaying the new value for the dynamic data item.

14. A computer-readable medium where contents cause a computer system to display the current values of dynamic variables of a computer program while the computer program is executing:
displaying a representation of at least a part of the computer program, including representations of a plurality of dynamic variables of the computer program;
executing the computer program;
determining that a user has positioned a cursor to point to a representation of a selected dynamic variable; and
displaying, at a position proximal to the representation of the selected dynamic variable, an identification of the selected dynamic variable and the current value of the selected dynamic variable based upon the execution of the computer program.

15. The computer-readable medium of claim 14, wherein the contents of the computer-readable medium further cause the computer system to:
after displaying the current value of the selected dynamic variable, receiving a new value for the selected dynamic variable; and
displaying the new value for the selected dynamic variable.

16. A method in a computer system for displaying a current value for a displayed dynamic data item, the computer system having a pointing device that may be manipulated by a user to position a cursor on a display, the dynamic data item being defined in a computer program, the method comprising:
determining that the user has positioned the cursor over the displayed dynamic data item in a window, using the pointing device; and
in response to such determining, displaying in a position adjacent to the displayed dynamic data item the current value of the displayed dynamic data item without any activatable controls.

17. The method of claim 16, further comprising:
receiving a new value for the displayed dynamic data item; and
in response to receiving the new value, automatically replacing the value of the displayed dynamic data item with the new value.

18. A computer-readable medium whose contents cause a computer system to display the current value of dynamic variables of a computer program while the computer program is executed by:
displaying in a window on a display screen a representation of at least a part of the computer program, including representations of at least one dynamic variable of the computer program;
executing the computer program;
determining that a user has positioned a cursor to point to a representation of a selected dynamic variable; and
displaying, at a position proximal to the representation of the selected dynamic variable, the current value of the selected dynamic variable without any activatable controls.

19. The computer-readable medium of claim 18, wherein the contents of the computer-readable medium cause the computer system to additionally perform:
receiving a new value for the selected variable; and
in response to receiving the new value, automatically replacing the value of the selected dynamic variable displayed with the new value.

20. A method for reducing user distraction in a source program debugger, the method comprising:
displaying at least a portion of a source program comprising text and white space, wherein the text includes commands and data items;
in response to movement of a pointing device, positioning a cursor on a particular portion of the source program;
determining if the cursor has remained on the particular portion of the source program for a predetermined period of time;
determining if the particular portion of the source program pointed to comprises a data item;
if the particular portion of the source program pointed to comprises a data item and the cursor has remained on the particular portion of the source program for the predetermined period of time;
determining a first value of a variable represented by the data item;
displaying the name of the variable and the first value in a first display;
receiving a second value of the variable; and
displaying the second value of the variable in a second display without requiring any keystroke input.

21. The method of claim 20, wherein the data item is delimited by a left delimiter and a right delimiter, wherein the left delimiter is determined by finding a character other than an alphanumeric or underbar character to the left of the data item and wherein the right delimiter is determined by finding a character other than an alphanumeric or underbar character to the right of the data item.
